(19) United States
(12) Patent Application Publication
(10) Pub. No.: US 2026/0199166 A1
(43) Pub. Date: Jul. 16, 2026

(54) A POSTURE ALIGNMENT SYSTEM

(71) Applicant: Formi Group Pty Ltd., Woollahra, NSW (AU)

(72) Inventors: Andrew Charles SIMPSON, Woollahra, NSW (AU); Charles Arthur PAYNE, Woollahra, NSW (AU); Eloise Anne MCGUFFICKE CLEARY, Woollahra, NSW (AU); Jonathan Ronald HAVENHAND, Woollahra, NSW (AU); Lana Lee HAVENHAND, Woollahra, NSW (AU)

(21) Appl. No.: 19/132,515

(22) PCT Filed: Nov. 23, 2023
(86) PCT No.: PCT/AU2023/051197

§ 371 Date: May 23, 2025

(30) Foreign Application Priority Data
Nov. 23, 2022 (AU) 2022903553

(51) Int. Cl. A61G 13/12; A47C 7/42; A47C 7/46; A47C 16/02; A47D 13/08; A61G 13/00

(52) U.S. Cl. CPC A61G 13/1295; A47C 7/42; A47C 7/46; A47C 16/02; A47D 13/08; A61G 13/009; A61G 13/1225; A61G 13/1235; A61G 13/125

(57) ABSTRACT

A posture alignment system 1, including a foot support 2, an arm support 3 and a back support 4. The supports 2,3,4 are adapted in use to cooperate together to position a user's body in a predetermined alignment having an optimal centre of mass angle A with respect to a surface to provide an overall supported body alignment that will reduce the onset of aches and pains.

### FIELD

The present invention relates to body pains and strains. In particular, the invention relates to an overall body posture alignment system to reduce body pains and strains.

The invention has been developed primarily for use with new parents and will be described hereinafter with reference to these applications. However, it will be appreciated that the invention is not limited to this particular field of use and may also be employed in other applications involving body pains and strains, for example, the elderly, disabled or to assist in the sport and wellness fields. Also, for example, workplace and home offices, health facilities and hospitals, physiotherapy and health consultants such as lactation specialists, watching television, gaming, reading, dining or on transport.

### BACKGROUND

Referring to the struggles of new parents, particularly mothers, they often encounter unexpected pains and body strains related to nursing/feeding of their babies.

Feeding a baby, for at least the first year, is a full-time job requiring a significant number of hours. Rarely do new parents consider their posture and often simply focus on the task at hand, being feeding the baby. Contributing to this pain is the fact that most furniture is not designed or set up to create an optimal feeding position to support parents and carers.

The optimal ergonomic position of a user when sitting is drawn from workstation ergonomics. For example, a user should aim for approximately 90-degree angles at all key joints to ensure a neutral position (see FIG. 1), without flexing or straining any parts of the body, position the feet up to angle the body back to spread the load across the legs, ensuring the head is supported and providing a backrest to support posture angle.

Due to increased hormone levels, for example, feeding mothers become ‘floppy’. They need structural rigidity when feeding to counteract the hyper-mobility from ‘Relaxin’ and to support their weakened limbs to return to the recommended neutral position (FIG. 1).

Relaxin softens ligaments to make space for the growing baby and helps ‘relax’ a woman's body during late pregnancy and in preparation for childbirth. Relaxin also affects the other joints in the body, in particular the hip joints, shoulders, and the joints in the feet and ankles. The resultant ligament laxity and hyper mobility can be long lasting and can cause pain and altered biomechanics. The hormones remain active for many months following birth or the conclusion of breastfeeding and so care must be taken to ensure correct posture is maintained to avoid long term structural body pains.

An injury, ‘Mommy's Wrist’ is quite common in new parents. It occurs when parents and carers repeatedly torque their wrists and hands in awkward positions to pick up, hold, and nurse babies. Creating an optimal feeding position can prevent this problem. This is not helped by the fact that existing chairs and nursing pillows have a tendency to hunch the occupants which leads to bad posture and pain.

For a baby, particularly a newborn, vomiting is normal and so they should be positioned expecting this to occur. Most nursing pillows do not consider this issue and vomit builds up in surrounding pillows, harboring bacteria. The current nursing pillows, for example, are rarely water-resistant, and are not designed for correct overall body posture alignment.

Further, nursing backrests incorporated in some nursing pillows to date are typically designed to support the lumbar and have not been designed for correct overall body posture alignment. They do not support the thoracic which is the main physical pain point acknowledged by physiotherapists for post-partum pain and is identified as the primary pain point before the pain spreads to the lumbar.

Though the traditional C (or U) shaped nursing pillow is popular, it is very tight and restrictive at its centre, and the shape is distorted when it wraps around the waist of the user. It is also designed as one-size fits all and doesn't accommodate for diversity in the gender, shape and size of users.

The C (or U) shaped pillows set the baby up to sit on a ‘tray’; because they're lying flat, the mother needs to lean forward to engage the right latch position for breastfeeding, which requires more muscle engagement and causes strain. Further, the pillow or support needs to create an appropriate feeding angle to mitigate reflux and to aid digestion, this is not supported by the flat position created by a ‘tray’.

Similarly, current footrests used by a new parent typically include standard footrests, stools, stacks of magazines, Tupperware, boxes or the like. They have not been designed for correct overall body posture alignment.

Further, current footrests used by parents typically do not create best positioning for feeding. Creating a posture that is slightly leaned back allows gravity to roll the baby towards the breast for feeding. This is better for latching and promotes baby-led attachment which is less stressful for the baby and more ergonomically appropriate for the mother.

The majority of existing products do not allow the user to adjust the device to conform to a tailored angle or height, which is key to creating overall body alignment and an optimal feeding position.

There is a need for a posture alignment system that proactively reduces the pain and discomfort that comes from sitting while caring for a baby. The system should create best practice ergonomic and feeding positioning of a user.

### SUMMARY

It is an object of the present invention to substantially overcome, or at least ameliorate, one or more of the disadvantages of existing arrangements, or at least provide a useful alternative to existing arrangements.

There is disclosed herein a posture alignment system, including a foot support, an arm support and a back support; said supports adapted in use to cooperate together to position a user's body in a predetermined alignment having an optimal centre of mass angle with respect to a surface to provide an overall supported body alignment.

Preferably, the foot support provides an angled platform for a user's feet which in use encourages the user to lean backwards distributing the centre of mass load of the user across the body.

Preferably, the foot support encourages the user to rock back and forth assisting a user's blood circulation.

Preferably, the back support extends along the majority of a user's back supporting the angle created by the foot support and supporting a user's thoracic.

Preferably, the back support has an adjustable lumbar support.

Preferably, the foot support and back support cooperate to, in use, create a neutral position through a net centre between the head, back and pelvis.

Preferably, the arm support encourages a user's arms to be in a position to encourage a user's body into the desired center of mass angle by the use of a pair of opposing arcuate curved surfaces.

Preferably, the arm support can be used by both arms.

Preferably, the position provides an ideal angle for baby feeding.

Preferably, each support includes a core of a material firmer than the surrounding material.

Preferably, an outer layer of the arm and back supports include a viscoelastic polyurethane foam.

Preferably, the supports include a water-resistant cover.

Preferably, the arm support includes a layer of fabric upholstery, a water-resistant protection layer, two layers of viscoelastic polyurethane foam on a core of HDPU foam.

Preferably, the back support includes a layer of fabric upholstery, a water-resistant protection layer, a layer of viscoelastic polyurethane foam on a core of HDPU foam.

Preferably, the foot support is of a single moulded PUR foam construction.

Preferably, the system positions a user to have approximately 90-degree angles at all key joints to ensure a neutral position.

### BRIEF DESCRIPTION OF THE DRAWINGS

For a more complete understanding of the present invention, exemplary embodiments of the invention are explained in more detail in the following description with reference to the accompanying drawing figures, in which like reference signs designate like parts and in which:

FIG. 1 shows an optimal position for feeding a baby;

FIG. 2 shows a posture alignment system of an embodiment of the present invention;

FIGS. 3a-g show an arm support of an embodiment of the present invention;

FIGS. 4a-g show a back support of an embodiment of the present invention; and

FIGS. 5a-d show a foot support of an embodiment of the present invention.

### DETAILED DESCRIPTION

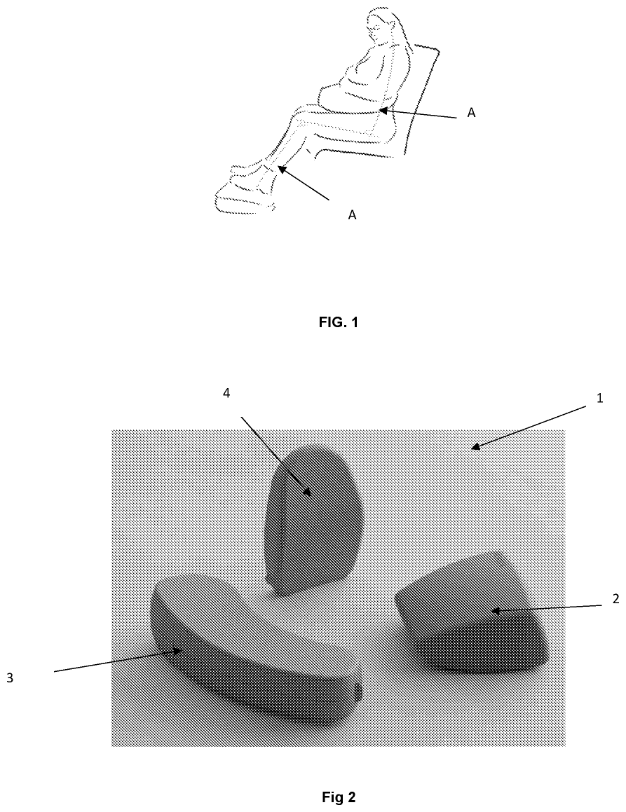

Referring to FIG. 2 of the accompanying drawings there is depicted a posture alignment system 1, including a foot support 2, an arm support 3 and a back support 4. The supports 2,3,4 are adapted in use to cooperate together to position a user's body in a predetermined alignment (see FIG. 1) having an optimal centre of mass angle A with respect to a surface to provide an overall supported body alignment that will reduce the onset of aches and pains.

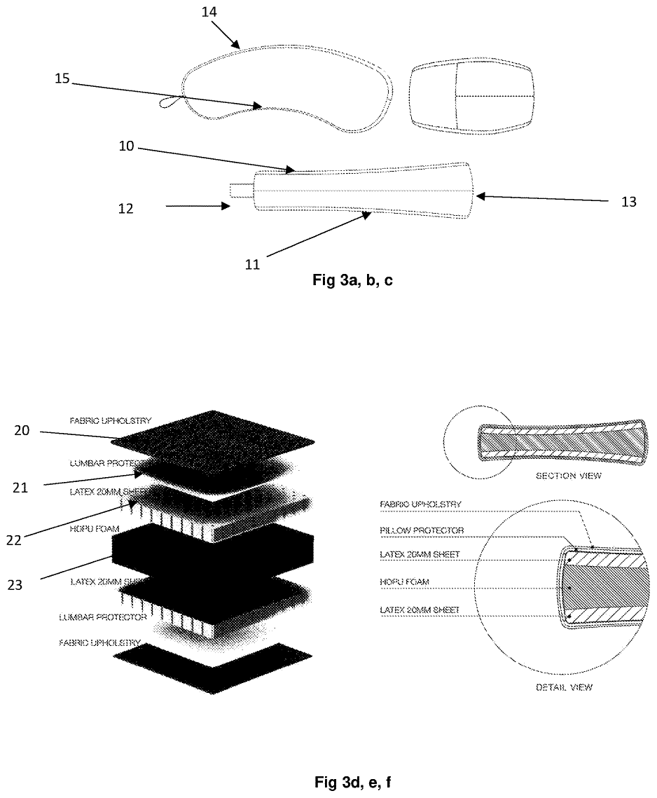

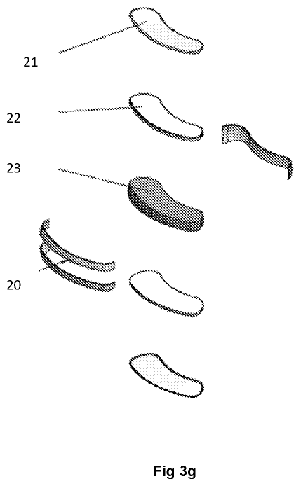

In the embodiment depicted in FIGS. 3 a to g there is shown an arm support 3 of an embodiment of the present invention. As best seen in FIG. 3c, the arm support 3 encourages a user's arms to be in a position to encourage a user's body into the desired center of mass angle A by the use of a pair of opposing arcuate curved surfaces 10,11. This creates one end 12 of the arm support 3 being thinner than the other end 13. As seen in FIG. 3a, the arm support 3 also has a pair of arcuate sides 14,15 when seen from a top view. The arm support 3 is preferably manufactured of a layer of fabric upholstery 20, a water-resistant protection layer 21, two layers of viscoelastic polyurethane foam 22 on a core of HDPU foam 23. A parts exploded view and cross sectional views are shown in FIGS. 3 d-g. In a preferred form, the arm support 3 would have a feeding angle between 5-8 degrees, an overall length between 560-600 mm and an internal radius (towards stomach) of 345 mm. It should however be appreciated that other materials and combinations of layers, shapes and sizes could be utilised if they achieve the desired outcome.

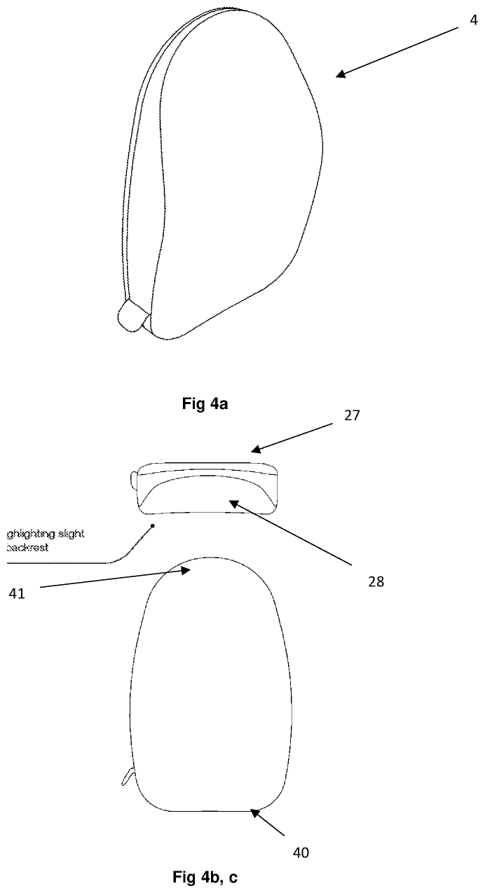

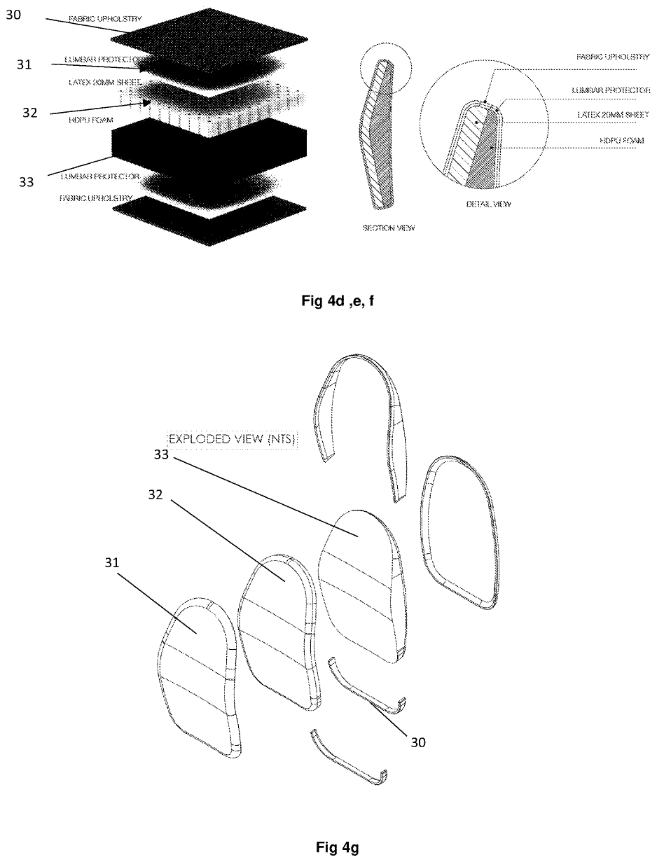

The back support 4, shown in the embodiment depicted in FIGS. 4 a to g, extends along the majority of a user's back supporting the angle created by the foot support and supporting a user's thoracic. It has a generally flat back surface 27 and a curved front surface 28. The support 4 has a wider base 40 and a narrower top 41. As best seen in FIG. 4a, the support 4 is thicker at the base The back support 4 is preferably manufactured of a layer of fabric upholstery 30, a water-resistant protection layer 31, a viscoelastic polyurethane foam layer 32 on a core of HDPU foam 33 (High density polyurethane). A parts exploded view and cross sectional views are shown in FIGS. 4 d-g. The back support 4 could include one or more adjustable lumbar supports. In the preferred form, the back support 4 (lumbar) would have a lumbar thickness (thickest mid-point) between 40-60 mm and an overall height between 360-380 mm. It should however be appreciated that other materials and combinations of layers, shapes and sizes could be utilised if they achieve the desired outcome.

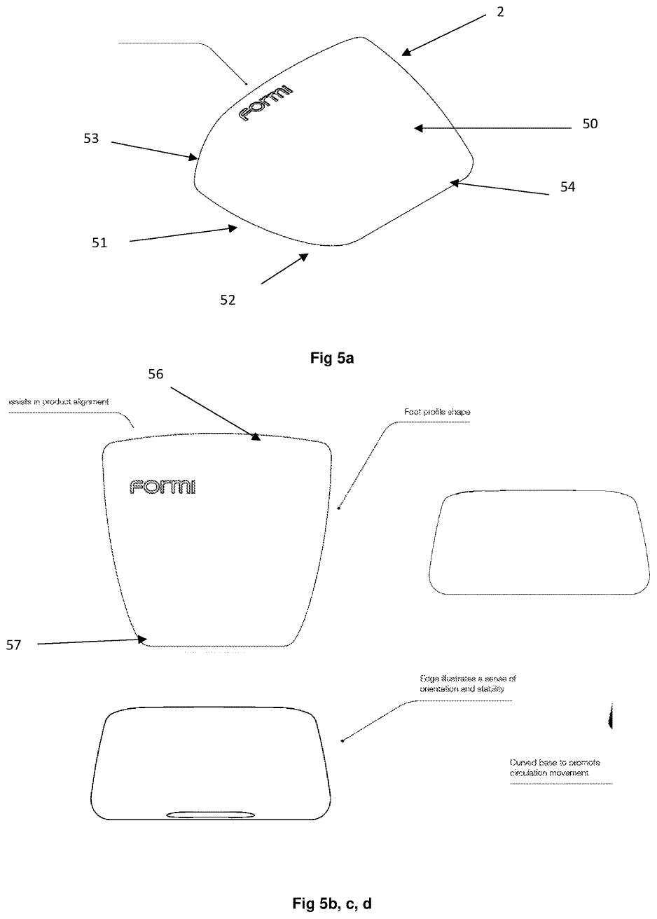

Referring now to the embodiment depicted in FIGS. 5a to d, there is shown a foot support 2 of an embodiment of the present invention. The foot support 2 provides an angled platform 50 for a user's feet which in use encourages the user to lean backwards changing the centre of mass angle A of the user. The foot support 2 is of a single moulded PUR foam construction (rigid polyurethane). It has a generally arcuate side 51 with a curved lip 52 leading to the angled platform side 50. The arcuate side 51 encourages the user to rock back and forth assisting a user's blood circulation. The support 2 is thicker at one end 53 than the other end 54. As best seen in FIG. 5b the support 2 also curves inwardly having a longer top end 56 to base end 57. In the preferred form, the foot support 2 (or footstool) would have a height of between 150-170 mm, a side profile view angle radius of 600 mm and a length between 300-320 mm. It should however be appreciated that other materials and combinations of layers, shapes and sizes could be utilised if they achieve the desired outcome.

The present invention therefore in at least a preferred embodiment aims to address one of the biggest physical pain points acknowledged by the health care system for post-partum, thoracic pain. The thoracic is the upper middle back region (shoulder blades to upper ribcage).

Reaching an optimal position is integral, as 35% of mass is positioned between the collar bone and the belly button. The key aim when positioning for feeding a baby is to remain in a neutral position where no one point is too compressed. Where there is compression, there is lengthening causing tension and damage. By creating a neutral position through a net centre between the head, back and pelvis, you alleviate pain. Net centre aligns the head over the pelvis. Position the feet up to angle the body back to spread the load across the legs. Best positioning for feeding is allowing the baby to come to the parent. This supports ergonomics and best practice for latching. The aim is to achieve approximately 90-degree angles at all key joints to ensure a neutral position, without flexing or straining any parts of the body. Compromise the hip and knee joints over the arms to evenly distribute the load and provide relief to the arms and wrists. The supports in alternate embodiments include handles, tags, straps and the like extending from a side of the supports to assist users with easy transport and/or placement of the supports. In an alternate embodiment, the supports are shaped so that they can nest together to form a cube or the like for easy transport and/or sale.

Advantageously the present invention at least in a preferred embodiment proactively reduces the pain and discomfort that comes from feeding babies by creating best practice ergonomic and feeding positioning. The system also helps those that want to breastfeed to continue to (for as long as they want) by providing the physical support and best practice positioning they need. The system provides supports which are safe, innovative, inclusive, and beautiful.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

1. A posture alignment system, including a foot support, an arm support and a back support; said supports adapted in use to cooperate together to position a user's body in a predetermined alignment having an optimal centre of mass angle with respect to a surface to provide an overall supported body alignment.

2. The system of claim 1, wherein the foot support provides an angled platform for a user's feet which in use encourages the user to lean backwards distributing the centre of mass load of the user across the body.

3. The system of claim 1, wherein the foot support encourages the user to rock back and forth assisting a user's blood circulation.

4. The system of claim 1, wherein the back support extends along the majority of a user's back supporting the angle created by the foot support and supporting a user's thoracic.

5. The system of claim 1, wherein the back support has an adjustable lumbar support.

6. The system of claim 1, wherein the foot support and back support cooperate to, in use, create a neutral position through a net centre between the head, back and pelvis.

7. The system of claim 1, wherein the arm support encourages a user's arms to be in a position to encourage a user's body into the desired center of mass angle by the use of a pair of opposing arcuate curved surfaces.

8. The system of claim 1, wherein each support includes a core of a material firmer than the surrounding material.

9. The system of claim 1, wherein an outer layer of the arm and back supports include a soft viscoelastic polyurethane foam.

10. The system of claim 1, wherein the supports include a water-resistant cover.

11. The system of claim 1, wherein the arm support includes a layer of fabric upholstery, a water-resistant protection layer, two sheets of viscoelastic polyurethane foam on a core of HDPU foam.

12. The system of claim 1, wherein the back support includes a layer of fabric upholstery, a water-resistant protection layer, a sheet of memory foam on a core of HDPU foam.

13. The system of claim 1, wherein the foot support is of a single moulded PUR foam construction.

14. The system of claim 1, wherein the system positions a user to have approximately 90-degree angles at all key joints to ensure a neutral position.
